(19) United States
(12) Patent Application Publication
(10) Pub. No.: US 2006/0242117 A1
(43) Pub. Date: Oct. 26, 2006

(54) Information storage medium capable of being searched for text information contained therein, reproducing apparatus and recording apparatus therefor

(76) Inventors: Hyun-Kwon Chung, Gwangju-si (KR); Jung-Wan Ko, Suwon-si (KR); Jung-Kwon Heo, Seoul (KR)

Correspondence Address: STEIN, MCEWEN & BUI, LLP, 1400 EYE STREET, NW, SUITE 300, WASHINGTON, DC, 20005, US

(21) Appl. No.: 10/526,554

(22) PCT Filed: Sep. 5, 2002
(86) PCT No.: PCT/KR02/01684

§ 371 Date: May 9, 2006

(51) Int. Cl. G06F 17/30

(52) U.S. Cl. 707/3

(57) ABSTRACT

A reproducing apparatus and/or a recording apparatus each including a browser for reproducing data on an information storage medium having registry information, includes a search unit for searching for the registry information based on an input search parameter and a search interface unit for receiving a search parameter from the browser and providing the search parameter to the search unit, and receiving text information from the search unit and transmitting the text information to the browser. Accordingly, text information on contents of an information storage medium can be searched.

### CROSS-REFERENCE TO RELATED APPLICATIONS

This application claims the benefit of PCT International Application No. KR2002/1684, filed Sep. 5, 2002 in the Korean Intellectual Property Office, the disclosure of which is incorporated herein by reference. Additionally, this application is based on Korean Patent Application No. 2001-12896 filed on Mar. 13, 2001, laid-open on Sep. 19, 2002.

### BACKGROUND OF THE INVENTION

1. Field of the Invention

The present invention relates to a recording/reproducing apparatus capable of accessing the Internet, and more particularly, to a recording/reproducing apparatus capable of searching for contents that have been recorded on an information storage medium.

2. Description of the Related Art

A digital versatile disc (DVD) reproducing apparatus having a web-browser for accessing the Internet and performing web surfing and a DVD for such a DVD reproducing apparatus (i.e., an interactive DVD) have been provided. In the case of an interactive DVD, when the DVD is inserted into the DVD reproducing apparatus, a hypertext markup language (HTML) document, which is stored in the DVD or the DVD reproducing apparatus, is displayed. Here, menu information is displayed as an HTML document by which a user can select desired contents.

Here, an applet or a script having a search function may be coded and inserted into the HTML document so that the user can search for text information in the contents recorded on the DVD. However, it is inefficient to code and operate an applet or a script in order to have a search function for the following reasons.

A conventional interactive DVD does not include a search function for searching for text information in the contents. Accordingly, when the search function is realized, for example, by using JavaScript, text strings corresponding to search parameters input by a user have to be recorded in an applet or a script by using an If syntax, which increases the complexity and amount of coding. In particular, in order to search for text strings in different languages, the applets or the scripts including the text strings of each language have to be separately provided, which greatly increases the amount of coding. In addition, since the text strings defined in the applets or the scripts are only effective in the HTML documents including the applets or the scripts, even the same text strings have to be defined in each HTML document. In other words, the coding of the applet or the script takes a long time and the operation of the applet or the script requires a large amount of memory.

### SUMMARY OF THE INVENTION

Aspects of the present invention provide an information storage medium for efficiently searching for text information in contents, a recording apparatus and a reproducing apparatus therefore.

Additional aspects and/or advantages of the invention will be set forth in part in the description which follows and, in part, will be obvious from the description, or may be learned by practice of the invention.

According to an aspect of the present invention, there is provided a reproducing apparatus, which includes a browser, for reproducing data on an information storage medium having registry information, comprising a search unit for searching for the registry information based on an input search parameter and a search interface unit for receiving a search parameter from the browser and providing the search parameter to the search unit, and receiving text information from the search unit and transmitting the text information to the browser.

In an aspect of the present invention, the registry information comprises a text data manager defined in a digital versatile disc (DVD), which is one type of the information storage media.

In an aspect of the present invention, the search interface unit is realized by using an application program interface (API).

In an aspect of the present invention, the browser includes an analysis engine for analyzing a predetermined client program inserted into a markup document, and the client program realizes the search interface unit.

In an aspect of the present invention, the client program is a Java Applet or JavaScript program, and the search interface unit is realized by at least one method defined in a class having a property parameter, which denotes at least one portion of information included in the text data manager.

In an aspect of the present invention, the search interface unit includes a search method for searching the text data manager and a property parameter, which is included in the class, for receiving text information on the text data manager.

In an aspect of the present invention, the search interface unit further comprises a previous search method for searching for data prior to the text information of the search method, and the search interface unit further comprises a next search method for searching for data posterior to the text information of the search method.

In an aspect of the present invention, the web document is recorded on the information storage medium.

In an aspect of the present invention, the search unit is realized as firmware, which interacts with the search interface unit, and the search unit comprises a search module for searching for text data which matches with the search parameter received from the search interface unit and an extraction module for extracting the data searched by the search module and transmitting the extracted data to the search interface unit.

According to another aspect of the present invention, there is provided a recording apparatus, which includes a browser, for recording contents on an information storage medium, comprising a recording unit for recording received registry information on the information storage medium, a recording interface unit for receiving registry information on contents, which are recorded on the information recording medium, from the browser and transmitting the registry information to the recording unit, a search unit for searching for the registry information based on an input search parameter, and a search interface unit for receiving a search parameter from the browser and providing the search parameter to the search unit, and receiving text information from the search unit and transmitting the text information to the browser.

In an aspect of the present invention, the recording apparatus further comprises a deletion unit for deleting received registry information from the information storage medium and a deletion interface unit for receiving predetermined registry information from the browser and transmitting the registry information to the deletion unit.

In an aspect of the present invention, the registry information comprises a text data manager defined in a DVD, which is one of the information storage media.

In an aspect of the present invention, the recording interface unit, the deletion interface unit, and the search interface unit are realized by using an API. The browser includes an analysis engine for analyzing a predetermined client program inserted into a markup document, and the client program realizes the recording interface unit, the deletion interface unit, and the search interface unit.

In an aspect of the present invention, the client program is a Java Applet or JavaScript program, and the recording interface unit, the deletion interface unit, and the search interface unit are realized by at least one method defined in a class having a property parameter, which denotes at least one portion of information included in the text data manager.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram illustrating a reproducing apparatus according to an embodiment of the present invention;

FIG. 2 is a block diagram for explaining the operation of the reproducing apparatus of FIG. 1;

FIG. 3 is a block diagram illustrating the relationship among a text data manager, a search interface unit, and a search unit;

FIG. 4 is an outline of a DVDObject Class provided for application program interface (API) of FIG. 3;

FIG. 5 is an example of a search interface unit realized based on the Class of FIG. 4;

FIG. 6 is a flowchart for explaining a search algorithm of a search module in a search unit, which searches according to FindTextData(LCD, TT, IDCD);

FIG. 7 is a flowchart for explaining an extraction algorithm of an extraction module in the search unit, which extracts according to FindTextData(LCD, TT, IDCD);

FIG. 8 is a flowchart for explaining another extraction algorithm of the extraction module in the search unit, which extracts according to FindTextData(LCD, TT, IDCD);

FIG. 9 is a flowchart for explaining a search algorithm of a search module in a search unit, which searches according to FindPreviousitemText(previous-n);

FIG. 10 is a flowchart for explaining a search algorithm of a search module in a search unit, which searches according to FindNextltemText(next-n);

FIGS. 11A and 11B are block diagrams illustrating a recording apparatus according to the embodiment of the present invention;

FIG. 12 is a block diagram illustrating an example of FIG. 11A; and

FIG. 13 is an outline of DVDObject Class realized according to the recording apparatus of FIGS. 11A and 11B.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

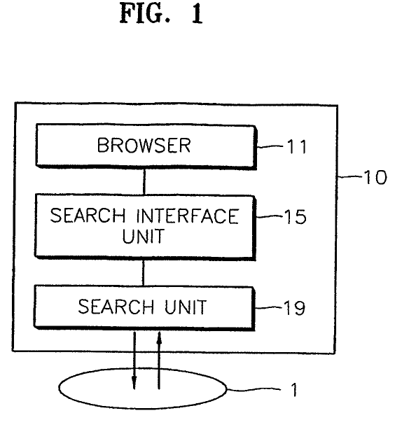

FIG. 1 is a block diagram illustrating a reproducing apparatus according to an embodiment of the present invention.

Referring to FIG. 1, a reproducing apparatus 10 includes a browser 11, a search interface unit 15 and a search unit 19.

The browser 11 recorded in a memory (not shown) of the reproducing apparatus 10 is a program executed by a CPU (not shown). Here, the browser 11 refers to a user interface for reading files online.

The search interface unit 15 interfaces the browser 11 with the search unit 19. In other words, the search interface unit 15 receives a search parameter from the browser 11 and supplies the search parameter to the search unit 19 and receives text information from the search unit 19 and sends the text information to the browser 11. The search unit 19 searches registry information recorded on a disc 1 by using the search parameter transmitted through the search interface unit 15 from the browser 11.

Meanwhile, the disc 1 contains at least one of contents, registry information, or documents, which can be displayed by the browser. Here, the registry information denotes text information on the contents recorded on the disc 1. Fields, which form the registry information, can be varied according to the characteristics of the contents. For example, the registry information for video content may include title, volume, language, production date, producer, leading actor and actress, and so forth. While not specifically so limited, it is understood that the disc 1 can include an information storage medium such as DVD-RWs, DVD-RAMs, DVD+RWs, as well as next generation high definition DVDs, such as Blu-ray discs and Advanced Optical Discs (AODs).

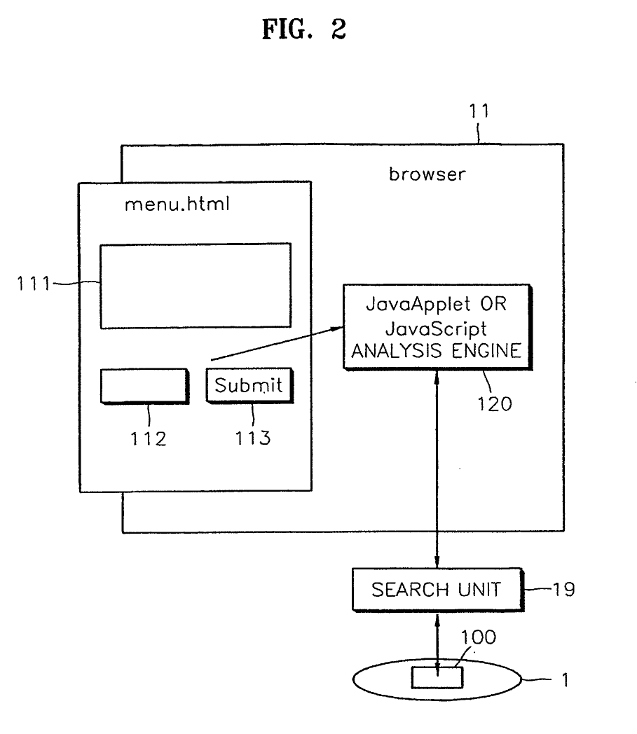

FIG. 2 is a block diagram for explaining the operation of the reproducing apparatus 10 of FIG. 1.

Referring to FIG. 2, the browser 11 includes a Java Applet or JavaScript analysis engine 120 as a client program analysis engine. Meanwhile, a digital versatile disc (DVD) 1 as an information storage medium contains a file called menu.html. The file menu.html, which is provided as a hypertext markup language (HTML) document, is a search page to search for text information in the content recorded on the DVD 1. Here, the HTML document is an example of a markup document for displaying predetermined information by the browser 11. The file menu.html may include and display images 111, which are recorded on the DVD 1. In addition, an input form 112 for inputting a search parameter and a submit button 113 for transmitting the search parameter are arranged in the file menu.html. The input form 112 and the submit button 113 interact with the Java Applet or JavaScript program, which is a client program for searching. In other words, the Java Applet or JavaScript program inserted into the file menu.html is analyzed by the Java Applet or JavaScript analysis engine 120 and transmitted to the search unit 19 by the browser 11 in order to perform the search function.

In addition, the DVD 1 includes a text data manager 100 as registry information on contents of the DVD 1. The text data manager 100 as text information for describing the contents recorded on the DVD 1 is defined in a DVD standard. The search unit 19 includes a search module for searching for text data that matches with the search parameter in the text data manager 100, and an extraction module for extracting the text data, which is searched for by the search module. Actually, the search unit 19 may be realized as firmware provided in the reproducing apparatus 10. Here, the firmware represents a program that is inserted into a program memory (not shown) in the reproducing apparatus 10 to be a part of the reproducing apparatus 10. The firmware can be distributed as software and installed in the reproducing apparatus 10. In addition, the firmware can be referred to as a microcode.

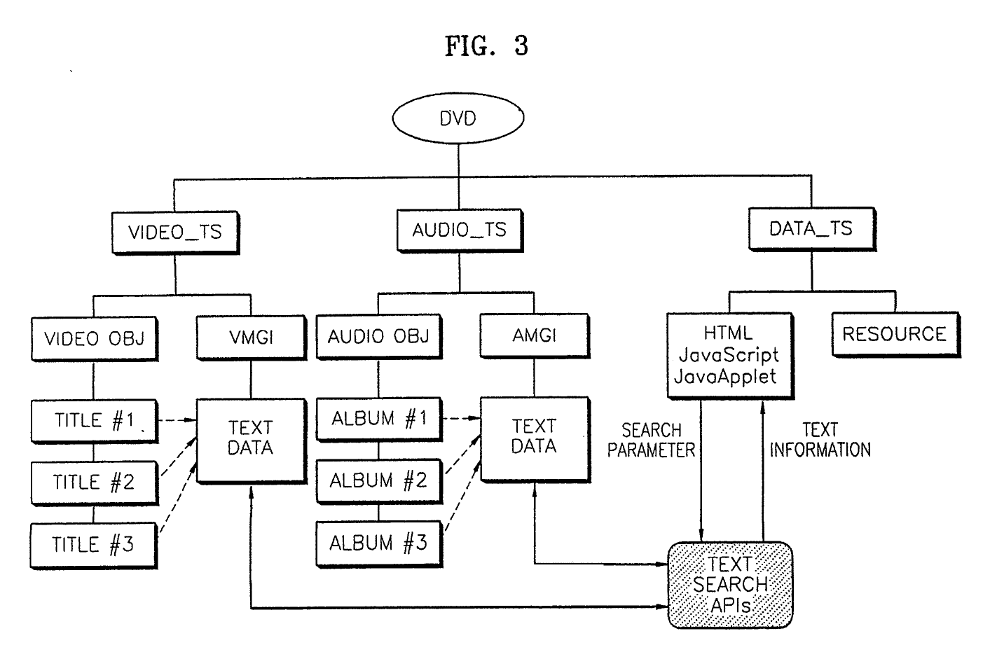

FIG. 3 is a block diagram illustrating the relationship among the text data manager 100, the search interface unit 15 and the search unit 19.

Referring to FIG. 3, the information recorded on a DVD is divided into a video title set Video_TS, an audio title set Audio_TS, and a data title set Data_TS.

The video title set Video_TS is separated into a video object Video OBJ and video manager information VMGI. The video object Video OBJ includes at least one title TITLE #1, #2, and #3. The video manager information VMGI includes text data, in which information on the at least one title included in the video object Video OBJ is defined. Here, the text data is included in the text data manager 100.

The audio title set Audio_TS is separated into an audio object Audio OBJ and audio manager information AMGI. The audio object Audio OBJ includes at least one album ALBUM #1, #2, and #3. The audio manager information AMGI includes text data, in which information on the at least one album included in the audio object Audio OBJ is defined. Here, the text data is included in the text data manager 100.

The data title set Data_TS includes an HTML document, such as menu.html of FIG. 2 that displays menus and resources. The resources include a bmp file or a JPEG file, which will be inserted into the menu.html file, such as the image 111 of FIG. 2. The HTML document includes a Java Applet or JavaScript program. The Java Applet or JavaScript program is operated by an application program interface (API), which is realized as the search interface unit 15 according to aspects of the present invention. To this end, the browser 11 analyzes the Java Applet or JavaScript program and transmits a search parameter comprising text information input by a user to the API. The API returns the text information to the browser 11.

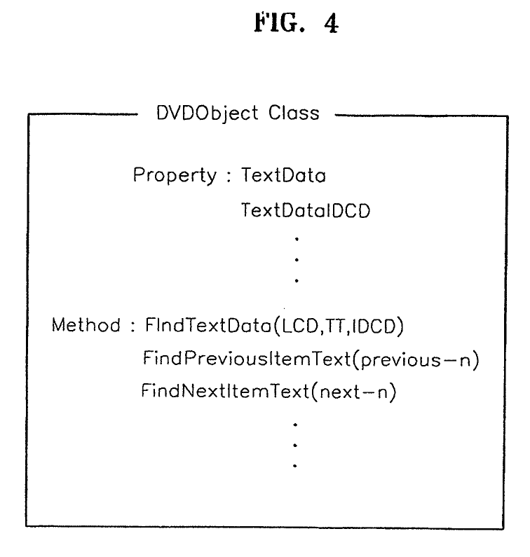

FIG. 4 is an outline of a DVDObject Class provided for the API of FIG. 3.

Referring to FIG. 4, the DVDObject Class is a template for defining property parameters and methods that are bases of the Java Applet or JavaScript program for searching for the text data manager 100 and includes TextData and TextDatalDCD as properties and FindTextData(LCD, TT, IDCD), FindPreviousltemText(previous-n), and FindNextitemText(next-n) as methods.

FindTextData(LCD, TT, IDCD) is a search method that searches for the text data manager. Here, LCD, TT, and IDCD are parameters for searching for text data included in the text data manager having a tree structure. More specifically, LCD denotes a language code, TT denotes a title in the case of DVD-Video and an album in the case of DVD-Audio, and IDCD denotes an identification code. For example, FindTextData(‘KR’, 0, 30h) commands the reproducing apparatus 10 to search for the name of volume in Korean.

FindPreviousltemText(previous-n) and FindNextltemText(next-n) are also search methods for searching for the text data manager. However, the above search methods can be performed after FindTextData(LCD, TT, IDCD) is performed. Here, previous-n and next-n denote parameters input from the user in order to perform the search methods. For example, FindPreviousltemText(10) commands the reproducing apparatus 10 to search for the previous tenth text data from the previously searched text data. FindNextltemText(9) commands the reproducing apparatus 10 to search for the next text data (i.e., ninth) from the previously searched text data.

TextData and TextDatalDCD are property parameters to return search data that are searched by performing the search method. Here, TextData is for returning a character string of the searched text data, for example, a return value x=DVDObject.TextData. TextDatalDCD is for returning the IDCD of the search data, for example, a return value x=DVDObject.TextDatalDCD. Here, the return value for TextDatalDCD is represented by a number.

When the DVDObject Class in which the properties and the methods are defined as the search interface unit 15 is generated, the Java Applet or JavaScript program inserted into an HTML document can be performed based on the DVDObject Class. In addition, the properties and the methods included in the DVDObject Class may be varied when necessary.

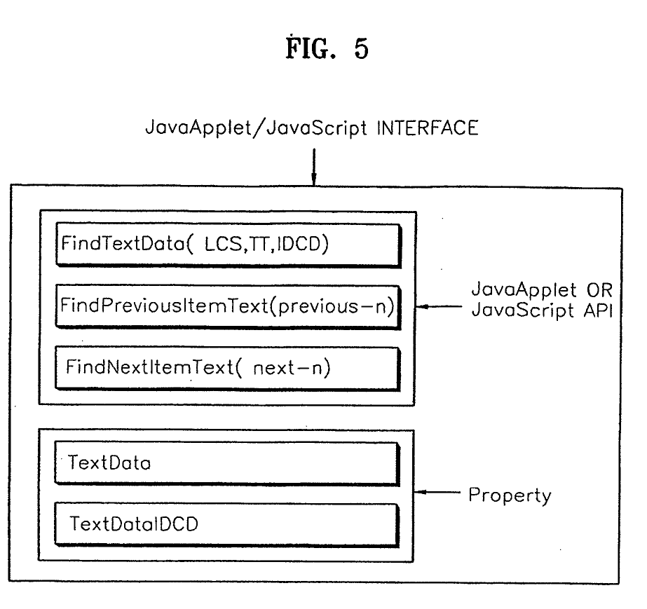

FIG. 5 is an example of the search interface unit 15 which is realized based on the DVDObject Class of FIG. 4.

Referring to FIG. 5, a Java Applet or JavaScript interface as the search interface unit 15 according to aspects of the present invention includes FindTextData(LCD, TT, IDCD), FindPreviousltemText(previous-n), and FindNextitemText(next-n) as a Java Applet or JavaScript API, and includes TextData and TextDataIDCD as property parameters.

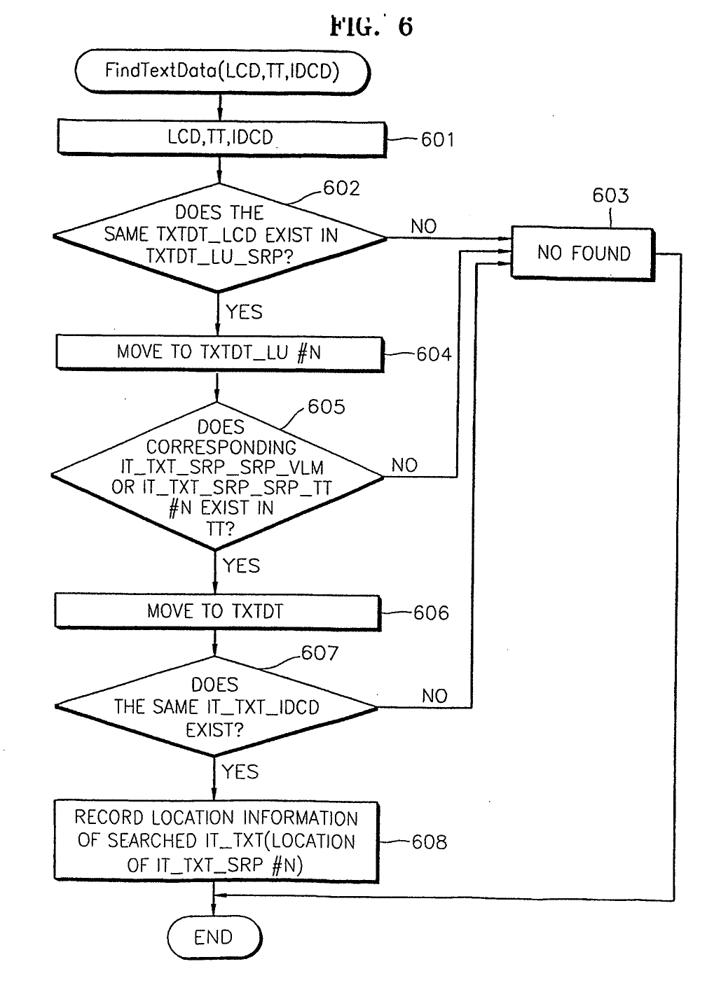

FIG. 6 is a flowchart for explaining a search algorithm of a search module in the search unit 19 which searches according to the FindTextData(LCD, TT, IDCD) method. Here, the search algorithm is performed according to the data structure of the text data manager 100 in a DVD. Accordingly, text data language code (TXTDT_LCD), text data language unit search pointer #n (TXTDT_LU_SRP #n), text data language unit #n (TXTDT_LU #n), item text search pointer search pointer for volume (IT_TXT_SRP_SRP_VLM), item text search pointer search pointer for title #n (IT_TXT_SRP_SRP_TT #n), text data (TXTDT), item text identification code (IT_TXT_IDCD), item text (IT_TXT), and item text search pointer #n (IT_TXT_SRP #n) denote data fields that are defined based on the data structure of the text data manager.

Referring to FIG. 6, FindTextData(LCD, TT, IDCD) receives values of parameters (i.e., LCD, TT, and IDCD) from a user in operation 601. First, it is detected whether text data having the same language code as the input language code (LCD) exists in a text data manager. In other words, TXTDT_LU_SRP #n denoting TXTDT_LCD is detected in operation 602. When the same language code does not exist in the text data manager (i.e., TXTDT_LCD is absent) the absence of text information is reported to a browser 11 in operation 603 and the search operation is ended.

When the same language code exists in the text data manager (i.e., TXTDT_LCD exists) the search module moves to TXTDT_LU #n with reference to a TXTDT_LU_SRP, in order to move to the location where the text data of the same language code is recorded in operation 604.

Thereafter, the existence of a title the same as the input title (TT) is detected in the text data of the same language code. More specifically, a search pointer denoting the location where the input TT is recorded (i.e., IT_TXT_SRP_SRP_VLM or IT_TXT_SRP_SRP_TT #n) is detected in operation 605. When the same TT does not exist, i.e., the corresponding search pointer is absent, the absence of the text information is reported to the browser 11 in operation 603 and the search operation is ended. When the IT_TXT_SRP_SRP_VLM or IT_TXT_SRP_SRP_TT #n exists, the search module moves to the location where the text data of the input TT is recorded (i.e., the corresponding TXTDT) with reference to the IT_TXT_SRP_SRP_VLM or IT_TXT_SRP_SRP_TT #n in operation 606.

In operation 607, it is detected whether text data having the same identification code as the input IDCD (i.e., IT_TXT_IDCD) exists in the TXTDT for the input TT When text data is absent, the absence of the text information is reported to the browser 11 in operation 603 and the search operation is ended. When text data having the same identification code exists in the TXTDT (i.e., when the IT_TXT_IDCD exists) the location information on the detected IT_TXT (i.e., the location of the corresponding IT_TXT_SRP #n) is stored in a memory (not shown) included in a search unit 19 in operation 608.

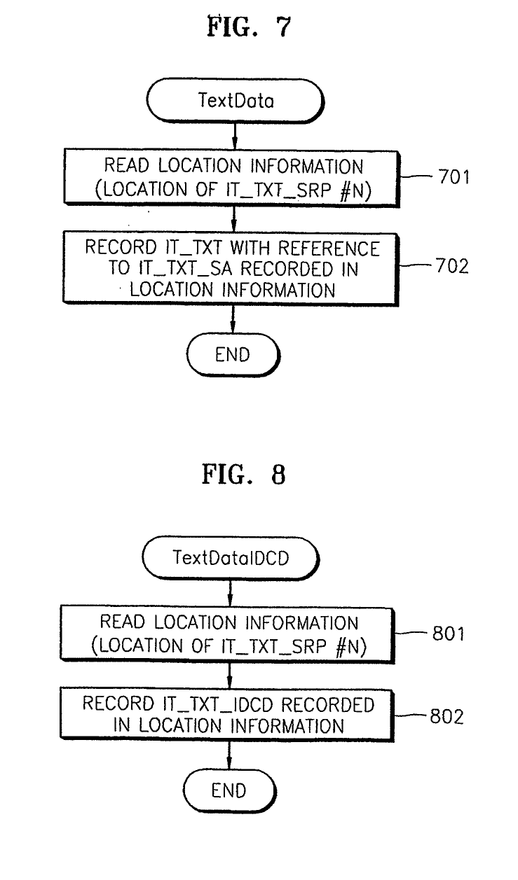

FIG. 7 is a flowchart for explaining an extraction algorithm of an extraction module in the search unit 19 which extracts text data according to FindTextData(LCD, TT, IDCD).

The extraction module extracts the text data searched by the search module using a property parameter TextData and transfers the extracted text data to the browser 11. A detailed extraction algorithm will now be described as follows. Referring to FIG. 7, the extraction module reads the location information stored in operation 608, which is the location information on IT_TXT (i.e., the location of IT_TXT_SRP #n) in operation 701. Next, the searched IT_TXT as a called TextData is stored in a memory (not shown) included in the search unit 19 with reference to an item text start address (IT_TXT_SA) recorded as the read location information in operation 702. In other words, the text data attained by the search operation is stored as a property parameter TextData. Accordingly, the browser 11 may display the text data attained by the search operation (i.e., IT_TXT) to a user.

FIG. 8 is a flowchart for explaining another embodiment of the extraction algorithm of the extraction module in the search unit 19 which extracts according to FindTextData(LCD, TT, IDCD). The extraction module extracts the text data searched by the search module using the property parameter TextDataIDCD and transfers the text data to the browser 11. A detailed extraction algorithm will now be described. Referring to FIG. 8, the extraction module reads the location information on IT_TXT stored in operation 608, i.e., the location of IT_TXT_SRP #n in operation 801. Next, the IT_TXT_IDCD recorded in the read location information is stored in a memory (not shown) included in the search unit 19 as a called TextDatalDCD in operation 802. In other words, the identification code of the text data attained by the search operation is stored as a property parameter TextDataIDCD. Accordingly, the browser 11 may display the text data attained by the search operation to a user.

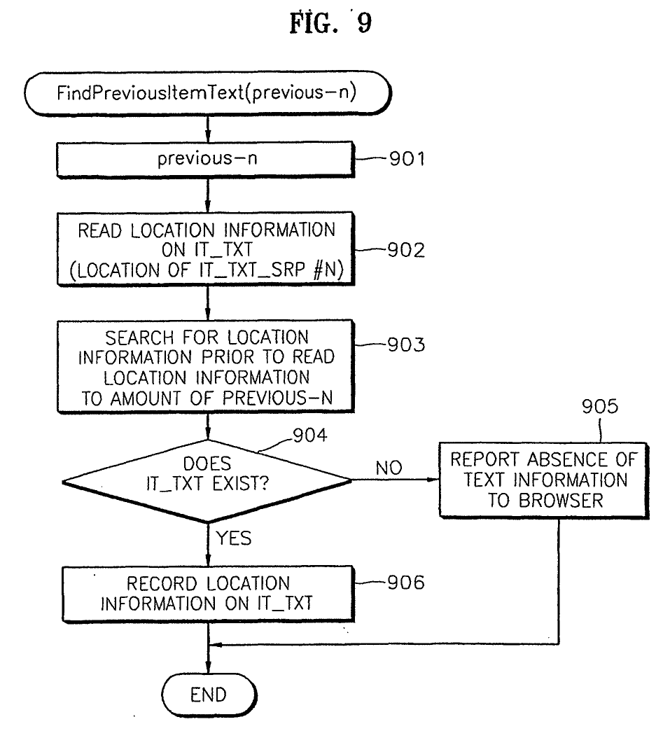

FIG. 9 is a flowchart for explaining a search algorithm of a search module in the search unit 19, which searches text data according to FindPreviousitemText(previous-n). The search module searches the text data by using the parameter previous-n. Referring to FIG. 9, FindPreviousitemText(previous-n) receives a value of a parameter input from a user (i.e., previous-n) in operation 901. First, the location information on IT_TXT recorded in operation 608 (i.e., the location of IT_TXT_SRP #n) is read in operation 902.

Thereafter, the previous location information from the read IT_TXT to the amount of previous-n is detected in operation 903.

The existence of text data corresponding to the searched location information, i.e., the existence of IT_TXT, is checked in operation 904. When IT_TXT is absent, the absence of the text information is reported to the browser 11 in operation 905 and the search operation is ended. When the IT_TXT exists, the location information on IT_TXT is recorded in a memory (not shown) of the search unit 19 in operation 906.

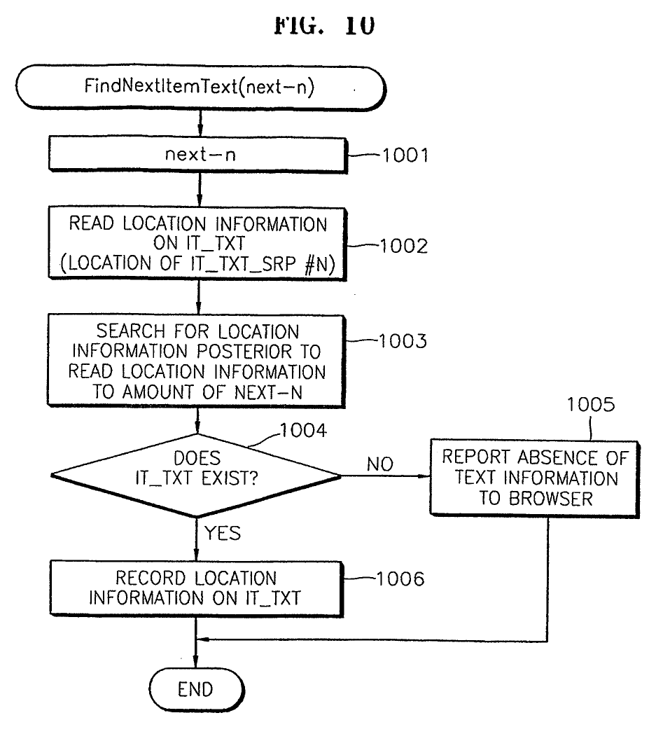

FIG. 10 is a flowchart for explaining a search algorithm of a search module in the search unit 19, which searches according to FindNextltemText(next-n). Here, the search module searches the text data by using a parameter next-n. More specifically, referring to FIG. 10, FindNextltemText(next-n) receives a parameter input from the user (i.e., next-n) in operation 1001. First, the location information on IT_TXT recorded in operation 608, i.e., the location of IT_TXT_SRP #n, is read in operation 1002.

Thereafter, the next location information from the read IT_TXT to the amount of next-n is detected in operation 1003.

The existence of text data corresponding to the searched location information (i.e., the existence of IT_TXT) is checked in operation 1004. When IT_TXT is absent, the absence of the text information is reported to the browser 11 in operation 1005 and the search operation is ended. When IT_TXT exists, the location information on IT_TXT is recorded in a memory (not shown) of the search unit 19 in operation 1006.

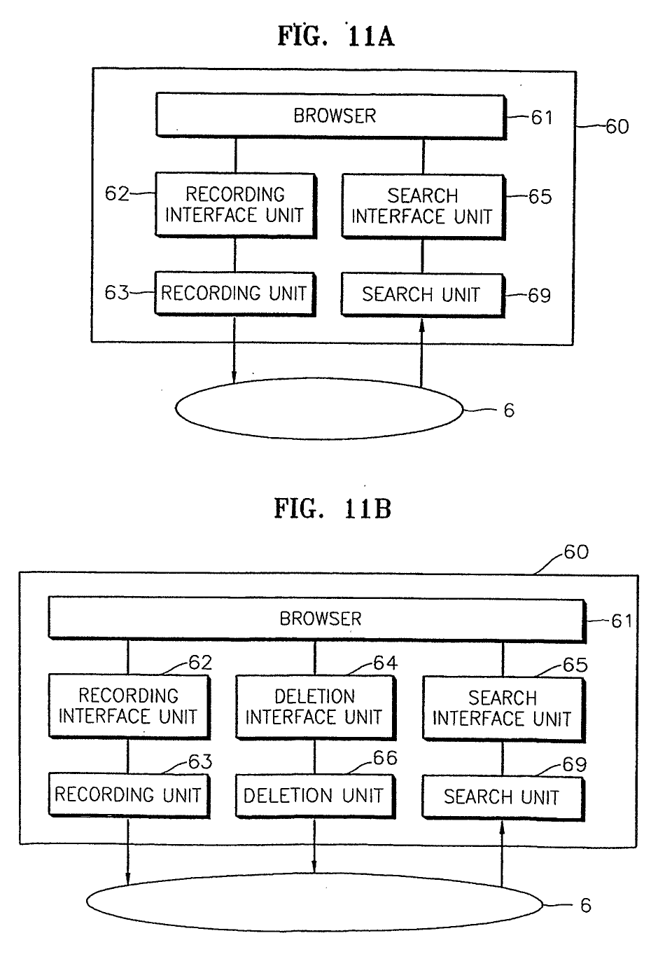

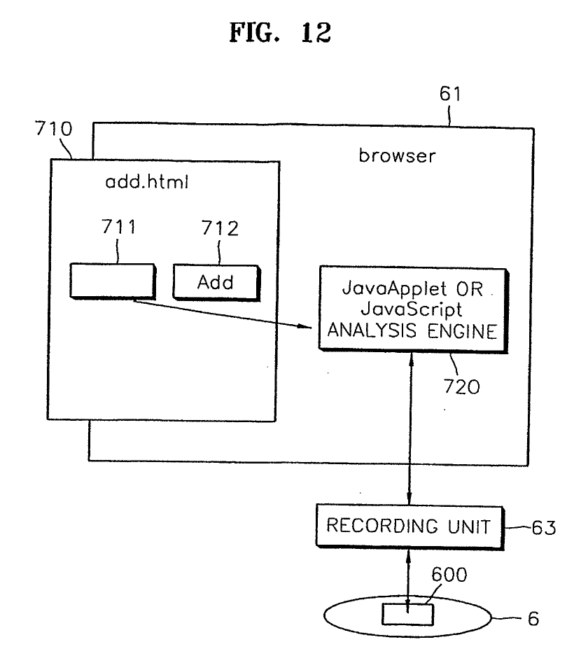

FIGS. 11A and 11B are block diagrams of a recording apparatus according to aspects of the present invention.

A recording apparatus 60 according to aspects of the present invention records contents on a DVD-rewritable and adds the text data about the recorded contents to a text data manager. Accordingly, the recording apparatus 60 includes a content recording unit (not shown) for recording the contents. Although the content recording unit can be realized in various forms, the function of adding new text data will be mainly described because a characteristic of the recording apparatus 60 according to aspects of the present invention is the function of adding new text data to the text data manager 600.

Referring to FIG. 11A, the recording apparatus 60 according to an embodiment of the present invention includes a browser 61, a recording interface unit 62, a recording unit 63, a search interface unit 65, and a search unit 69.

The browser 61, which is recorded in a memory (not shown) arranged in the recording apparatus 60, is a program run by a CPU (not shown). The browser 61 is a user interface for reading files online.

The recording interface unit 62 interfaces the browser 61 with the recording unit 63. In other words, the recording interface unit 62 receives information to be recorded from the browser 61 and sends the information to the recording unit 63. The recording unit 63 records the information from the recording interface unit 62 on an information storage medium 6 as registry information.

The information storage medium 6 includes at least one of contents, registry information, or documents, which can be displayed by a browser 61. Here, the registry information refers to text information on the contents to be recorded on the information storage medium 6. The fields that compose the registry information can vary according to the characteristics of the contents. For example, the registry information on video content may include title, volume, language, production date, producer, and leading actor and actress. As mentioned above, it is understood that the information storage medium 1 can include DVD-RWs, DVD-RAMs, DVD+RWs, as well as next generation high definition DVDs, such as Blu-ray discs and Advanced Optical Discs (AODs).

The search interface unit 65 interfaces the browser 61 with the search unit 69. In other words, the search interface unit 65 receives a search parameter from the browser 61 to send to the search unit 69 and receives text information from the search unit 69 to send to the browser 61. The search unit 69 searches for the registry information recorded on the information storage medium 6 by using the search parameter transferred through the search interface unit 65.

Referring to FIG. 11B, a recording apparatus 60 according to another embodiment of the present invention includes a browser 61, a recording interface unit 62, a recording unit 63, a deletion interface unit 64, a deletion unit 66, a search interface unit 65, and a search unit 69. The recording unit 60 of FIG. 11B includes the deletion interface unit 64 and the deletion unit 66, which the recording apparatus 60 of FIG. 11A does not have.

The deletion interface unit 64 interfaces the browser 61 with the deletion unit 66. In other words, the deletion interface unit 64 receives information to be deleted from the browser 61 and sends the information to the deletion unit 66. The deletion unit 66 deletes the information transferred through the deletion interface unit 64 from the registry information recorded on an information storage medium 6.

Since the browser 61, the recording interface unit 62, the recording unit 63, the search interface unit 65, and the search unit 69 are the same as those of FIG. 11A, they are allotted the same reference numerals and descriptions thereof will not be repeated.

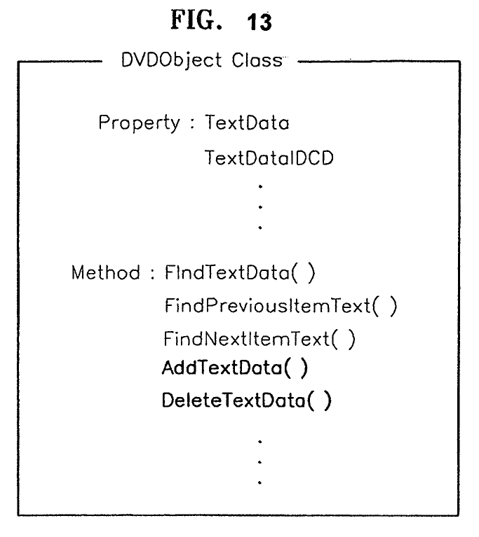

FIG. 12 is a block diagram for explaining an example of FIG. 11A.

Referring to FIG. 12, the browser 61 includes a Java Applet or JavaScript analysis engine 720 as a client program analysis engine and displays add.html 710, which is used by a user to add text data to a text data manager 600. An information storage medium 6, which in this case is a type of disc that includes the above-described add.html 710. Here, add.html 710, which is provided as an HTML document, is a search page used to add text information on the contents that are recorded on the information storage medium 6. An input form 711 for receiving information to be recorded on the information storage medium 6 and an add button 712 for transmitting information received by the input form 711 are arranged in add.html 710. The input form 711 and the add button 712 interact with the Java Applet or JavaScript program for recording the information. In other words, the Java Applet or JavaScript program inserted into add.html 710 is analyzed by the Java Applet or JavaScript analysis engine 720, and transmitted to the recording unit 63 by the browser 61 in order to perform the recording operation.

In addition, the information storage medium 6 includes a text data manager 600 as registry information on contents. The text data manager 600 as text information for describing the contents recorded on the information storage medium 6 is defined in, for example, a DVD standard. The recording unit 63 includes a recording module for adding new text data to the text data manager 600. Actually, the recording unit 63 may be realized as firmware provided in the recording apparatus 60. Here, the firmware represents a program that is inserted into a program memory (not shown) in the recording apparatus 60 and is a part of the recording apparatus 60. The firmware can be distributed as software and installed in the recording apparatus 60. In addition, the firmware can be referred to as microcode.

Meanwhile, the examples of FIGS. 11A or 11B can be realized as that of FIG. 12.

FIG. 13 is an outline of DVDObject Class realized according to the recording apparatus of FIGS. 11A and 11B.

Referring to FIG. 13, the DVDObject Class includes TextData and TextDatalDCD as properties and FindTextData( ), FindPreviousitemText( ), FindNextltemText( ), AddTextData(), and DeleteTextData( ) as methods. Compared to the DVDObject Class of FIG. 4, the DVDObject Class of FIG. 13 further includes AddTextData( ) and DeleteTextData( ). AddTextData( ) is a method for recording new text data to the text data manager 600 of the information storage medium 6. DeleteTextData( ) is a method for deleting specific text data from the text data manager 600 of the information storage medium. When the DVDObject Class, in which properties and methods are defined as the recording interface unit 62 and/or the deletion interface unit 64 in addition to the search interface unit 65, is generated, the Java Applet or JavaScript program, which is inserted into the HTML document, can be performed.

In addition, the properties and the methods included in the DVDObject Class may vary when necessary. Furthermore, the algorithms of the methods are realized by the same methods described with reference to FIGS. 6, 9, and 10.

An example of a source code of the JavaScript program included in the HTML document according to aspects of the present invention is as follows.

<html>
<head>
<title>Title Name Search</title>
<SCRIPT LANGUAGE=“JavaScript”>
<!-
function TitleNameSearch( )
{

x = document.form1.TitleNum.value
ret = DVDObject.FindTextData(‘KR’, x, 80)
if (ret == ok) {
document.writeIn(DVDObject.TextData)

}
// !-->
</SCRIPT>
</head>
<body bgcolor=“white” text=“black” link=“blue”
vlink=“purple” alink=“red”>
<OBJECT
CLASSID=“clsid:A0739DE5-571F-11D2-A0310060977F760C”

ID=DVDObject” HEIGHT=50% WIDTH=60%>

<form name=“form1”>

<p>Title Number:<input type=“text” name=“TitleNum” value=“1”
maxlength=“2”

size=“2”></p>

<input type=“submit” name=“TitleNameSearchBtn”
value=“TitleNameSearch”

OnClick=“TitleNameSearch( );”>

</form>
</body>
</html>

As described above, a reproducing apparatus and a recording apparatus according to aspects of the present invention efficiently search for text information in contents. In particular, a large amount of text information included in the text data manager of a digital versatile disc (DVD) can be easily searched like browsing websites, by using the reproducing apparatus and the recording apparatus according to aspects of the present invention. Thus, if the JavaScript application program interface (API) is used for searching for the text data manager of the DVD, a user can efficiently search for script, words of a song, actors and actresses, and movie scenes in contents. In the case of a DVD-rewritable, a predefined text data manager can be used as a correctable text database by using an API for adding and deleting text data.

Although a few embodiments of the present invention have been shown and described, it would be appreciated by those skilled in the art that changes may be made in this embodiment without departing from the principles and spirit of the invention, the scope of which is defined in the claims and their equivalents.

1. A reproducing apparatus which includes a browser, to reproduce data on an information storage medium having registry information, the reproducing apparatus comprising:
a search unit searching for the registry information based on an input search parameter; and
a search interface unit receiving the input search parameter from the browser and providing the input search parameter to the search unit, and receiving text information from the search unit and transmitting the text information to the browser.

2. The reproducing apparatus of claim 1, wherein the registry information comprises a text data manager defined in a digital versatile disc (DVD).

3. The reproducing apparatus of claim 2, wherein the search interface unit comprises an application program interface (API).

4. The reproducing apparatus of claim 3, wherein the browser includes an analysis engine for analyzing a predetermined client program inserted into a markup document, and the client program comprises the search interface unit.

5. The reproducing apparatus of claim 4, wherein the client program is a Java Applet or JavaScript program, and the search interface unit is realized by at least one method defined in a class having a property parameter, the property parameter indicating at least one portion of the text information included in the text data manager.

6. The reproducing apparatus of claim 5, wherein the search interface unit includes:
a search method searching the text data manager; and
a property parameters which is included in the class, receiving the text information on the text data manager.

7. The reproducing apparatus of claim 6, wherein the search interface unit further comprises a previous search method searching for data prior to the text information of the search method.

8. The reproducing apparatus of claim 6, wherein the search interface unit further comprises a next search method searching for data posterior to the text information of the search method.

9. The reproducing apparatus of claim 4, wherein the web document is recorded on the DVD.

10. The reproducing apparatus of claim 1, wherein the search unit comprises firmware which interacts with the search interface unit.

11. The reproducing apparatus of claim 10, wherein the search unit comprises:
a search module searching for text data which matches with the input search parameter received from the search interface unit; and
an extraction module for extracting the matched text data searched by the search module and transmitting the extracted text data to the search interface unit.

12. A recording apparatus, which includes a browser to record contents on an information storage medium, the recording apparatus comprising:
a recording unit recording received registry information on the information storage medium;
a recording interface unit receiving the registry information on contents, which are recorded on the information recording medium, from the browser and transmitting the registry information to the recording unit;
a search unit searching for the registry information based on an input search parameter; and
a search interface unit receiving the input search parameter from the browser and providing the input search parameter to the search unit, and receiving text information from the search unit based on the searching for the registry information and transmitting the text information to the browser.

13. The recording apparatus of claim 12, further comprising:
a deletion unit deleting received registry information from the information storage medium; and
a deletion interface unit receiving predetermined registry information from the browser and transmitting the registry information to the deletion unit.

14. The recording apparatus of claim 12, wherein the registry information comprises a text data manager defined in the information storage media.

15. The recording apparatus of claim 12, wherein the recording interface unit, the deletion interface unit, and the search interface unit each comprise an API.

16. The recording apparatus of claim 12, wherein the browser includes an analysis engine analyzing a predetermined client program inserted into a markup document stored in the browser, and the client program comprises the recording interface unit, the deletion interface unit, and the search interface unit.

17. The recording apparatus of claim 16, wherein the client program is a Java Applet or JavaScript program, and the recording interface unit, the deletion interface unit, and the search interface unit comprise at least one method defined in a class having a property parameters which denotes at least one portion of the text information included in a text data manager defined in the information storage medium.

18. The recording apparatus of claim 17, wherein the recording interface unit includes a recording method which records the text information to be included in the text data manager.

19. The recording apparatus of claim 17, wherein the deletion interface unit includes a deletion method which deletes the text information from the text data manager.

20. The recording apparatus of claim 17, wherein the search interface unit includes:
a search method searching the text data manager; and
a property parameters which is included in the class receiving the text information on the text data manager.

21. The recording apparatus of claim 20, wherein the search interface unit further comprises a previous search method searching data prior to the text information of the search method.

22. The recording apparatus of claim 20, wherein the search interface unit further comprises a next search method searching data posterior to the text information of the search method.

23. A recording and/or reproducing apparatus which transfers data with respect to an information storage medium, comprising:
a browser which generates a user interface corresponding to at least one of a search parameter input by a user, registry information corresponding to contents on the information storage medium or result data to be displayed to the user;
a recording unit recording the registry information and content data on the information storage medium;
a recording interface unit transferring the registry information from the browser to the recording unit;
a search unit searching the registry information based on the search parameter; and
a search interface unit receiving the search parameter from the browser and providing the search parameter to the search unit, and receiving the result data from the search unit based on the searching of the registry information and transmitting the result data to the browser to display to the user.

24. The recording and/or reproducing apparatus of claim 23, wherein the search unit comprises:
a search module which searches the registry information based on the search parameter; and
an extraction module extracting the registry information searched by the search module which matches the search parameter and transmitting the matching registry information to the search interface unit.

25. The recording and/or reproducing apparatus of claim 24, further comprising:
a deletion interface unit receiving selected registry information from the browser; and
a deletion unit deleting the received selected registry information from the information storage medium.

26. The recording and/or reproducing apparatus of claim 24, wherein the registry information comprises a text data manager defined in the information storage media.

27. The recording and/or reproducing apparatus of claim 26, wherein the information storage medium is a DVD.

28. The recording and/or reproducing apparatus of claim 27, wherein the text data manager comprises a text database which is modified by using the browser to add and/or delete at least one of the registry information, the content data or the result data.
